(19) United States
(12) Patent Application Publication
(10) Pub. No.: US 2002/0106166 A1
(43) Pub. Date: Aug. 8, 2002

(54) Self-lensing imaging of core eccentricity in optical fibers

(75) Inventor: Brett G. Clark, Whites Creek, TN (US)

Correspondence Address: BANNER & WITCOFF, 1001 G STREET N W, SUITE 1100, WASHINGTON, DC, 20001, US

(73) Assignee: Amherst Holding Co., Wilmington, DE

(21) Appl. No.: 10/038,810

(22) Filed: Jan. 8, 2002

Related U.S. Application Data
(60) Provisional application No. 60/259,900, filed on Jan. 8, 2001.

(51) Int. Cl. G02B 6/36; G02B 6/255

(52) U.S. Cl. 385/91; 385/95

(57) ABSTRACT

A method and system for providing precise alignment of optical fiber cores to prepare for the splicing thereof without requiring specialized splicer optical systems or extensive redesigns of existing splicer optical systems. The optical fibers themselves are used to magnify an image of the cores at the splice point of the optical for precise alignment thereof. That is, in an optical fiber splicer having an optical system, the imaging device utilizes the cladding of optical fibers that are to be spliced together to precisely align the axial cores of the optical fibers.

This application claims the benefit of priority from provisional patent application U.S. Serial No. 60/259,900, filed Jan. 8, 2001.

### FIELD OF THE INVENTION

The invention relates to a method and system for precisely aligning the cores of optical fibers that are to be spliced together, in particular using the cladding of the optical fibers themselves to produce a magnified image of the optical fiber cores for precise alignment thereof.

### BACKGROUND

Optical fibers may be constructed with a protective outer coating, called a “cladding”. When fusing the cores of optical fibers by aligning the claddings of the optical fibers, it is often found that the cores of the optical fibers are not well centered within the cladding of the respective optical fibers. That is, any splicing technique that is based upon the alignment of the claddings of optical fibers is highly vulnerable to misalignments of the cores of the respective optical fibers. The consequences of such misalignments of the optical fibers, even a misalignment of 0.1 μm, include loss of signal strength for signals transmitted through the resulting spliced optical fibers.

Therefore, techniques have been derived to determine the location of the cores within the claddings of the optical fibers before splicing thereof, so that the cores themselves may be aligned prior to splicing of the optical fibers.

One technique, called the “hot core alignment process”, requires that the optical fiber cores to be spliced together be heated to significant temperatures, e.g., 1600° C., resulting in the cores becoming clearly visible through the cladding of the respective optical fibers. Then the cores may be aligned based on visual observation thereof. However, the performance of various fibers may be adversely affected by such significant heating prior to splicing thereof.

On the other hand, so-called “cold image spaced alignment” techniques, which do not require that the optical fiber cores be heated, may be accompanied by undesirable drawbacks including requiring an objective lens that is positioned extremely close (e.g., <30 mm) to the optical fibers, requiring an objective lens having an extraordinarily high magnification level (e.g., >200×), and/or requiring a lens having a high image resolution (e.g., <0.5 μm/pixel). However, an objective lens that is placed less than 30 mm from an optical fiber cladding is placed at significant risk of surface damage. Further, the optical systems described above having significant magnification and resolution specifications would require specialized equipment, including significant redesign of existing optical equipment that is used in the field of optical fiber splicing.

Conversely, an example of a presently available optical fiber splicer may have an achromatic objective lens of 10 mm or less that may be disposed at a distance of at least 40 mm from the splice point of the optical fibers. The image of the splice point of the optical fibers may be projected onto a charge coupled device (CCD) in the splicer. The resolution of the device may be 1.5 μm/pixel. Such a splicer may produce the image shown in FIG. 3, which shows a single optical fiber 300 having a perfectly centered core. The central line 310 is known as the “lens effect line”, which may include a refracted image of the core, and may be produced even if a core is absent from the optical fiber 300. The lens effect line 310 obscures the core and thus the core is not visible in FIG. 3, which is a CAD (computer-aided designed)-produced negative image of a single optical fiber, shown at a magnification of 400×, to more clearly show the features therein.

FIG. 4 is a CAD-produced negative image of a single optical fiber 400, also shown at a magnification of 400×, that is captured by the optical system described above, having a core that is measured as being 1 μm off-center. However, the eccentricity is hidden by the lens effect line 410, which is more clearly shown by the negative imagery of the figure. Lens effect line 410 prevents detection of slightly misaligned cores because it obscures the core. This is a significant drawback because even a misalignment of 0.1 μm between spliced fibers may result in significant loss of strength for signals transmitted through the resulting spliced portion of the optical fibers. As a result of the image of FIG. 4, a technician performing or inspecting a splice would not be aware of the extent of the core eccentricity or even the existence of the core eccentricity. FIGS. 5 and 6 show, again using a CAD-produced negative image of a single optical fiber, the focused images of the optical fibers of FIGS. 3 and 4 respectively, at a magnification of 800×. However, because of the lens effect line, there is little observable difference between the perfectly aligned cores of FIGS. 3 and 5 and the misaligned cores of FIGS. 4 and 6.

### SUMMARY OF THE INVENTION

Thus, the present invention is directed towards a method and system for providing a substantially precise alignment of optical fiber without requiring specialized splicer optical systems or extensive redesigns of existing splicer optical systems. Further, the present invention enables optical fiber cores to be aligned with a significantly high degree of precision without requiring the heating of the optical fiber cores or significant redesign of currently implemented optical systems that are used in optical fiber splicer systems. In addition, the present invention enables optical fiber cores to be aligned with substantial precision without requiring expensive imaging equipment having to be disposed close to the optical fibers, particularly at distances where the imaging equipment may incur damage due to heat radiating from the optical fibers.

Rather, the present invention utilizes the optical fibers themselves to magnify an image of the cores at the splice point of the optical for precise alignment thereof. That is, in an optical fiber splicer having an optical system, the imaging device utilizes the cladding of optical fibers that are to be spliced together to produce the images that are used for precisely aligning the axial cores of the optical fibers.

First, the splicer must hold in place an end portion of the optical fibers along a same axial path, so as to splice together an end portion of each optical fiber. Then, the optical system, which has an objective plane that is perpendicular to the axial direction of the optical fibers, emits light onto the optical fibers in a direction that is orthogonal to the axial path of the optical fibers. The light rays emitted from the optical system onto the optical fibers may be collimated, to thereby eliminate any divergent rays and enter the optical fibers in parallel, by minute lenses that are disposed adjacent to the light emitting diodes (LEDs) of the optical system. As a result, the collimated light rays simulate a light source at infinity and located behind a 3 mm aperture.

An image of the splice point of the optical fibers is then defocused by orthogonally moving the objective plane of the optical system away from the axial direction of the optical fibers to a predetermined defocusing distance, which may be in the range of 300 to 350 μm. Thus, the light reflecting from the inside portion of the cladding behind the core of the optical fibers may produce multiple parallel line images corresponding to the optical fiber core that are projected by the objective plane onto a charge coupled device (CCD).

The optical device may then be utilized to capture a series of defocused images of the optical fibers along the axial path of the optical fibers, from more than one orthogonal position relative to the axial path of the optical fibers. Each of the resulting images is then filtered to remove any optical noise therefrom, and the core position of the optical fibers, particularly the end portions thereof, are then empirically determined in anticipation of splicing.

Accordingly, the present invention circumvents the need to redesign optical system utilized in conjunction with optical fiber splicers, by using the optical fibers themselves to produce the images required for precise alignment thereof.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written disclosure focus on disclosing example embodiments of this invention, it should be clearly understood that the same is by way of illustration and example only and the invention is not limited thereto. The spirit and scope of the present invention are limited only by the terms of the appended claims.

The following represents brief descriptions of the drawings, wherein:

FIG. 1 shows a flowchart for an example method for implementing the present invention.

FIG. 2A shows a schematic block diagram according to an example of the present invention;

FIG. 2B is a profile view of the example of FIG. 2A;

FIG. 2C is a schematic block diagram according to an example of the present invention showing defraction of light by an optical fiber having a perfectly centered core;

FIG. 2D shows a schematic block diagram according to an example of the present invention showing defraction of light by an optical fiber having an off-center core.

FIG. 3 shows an example of an image of an optical fiber having a perfectly centered core obtained by a prior art system.

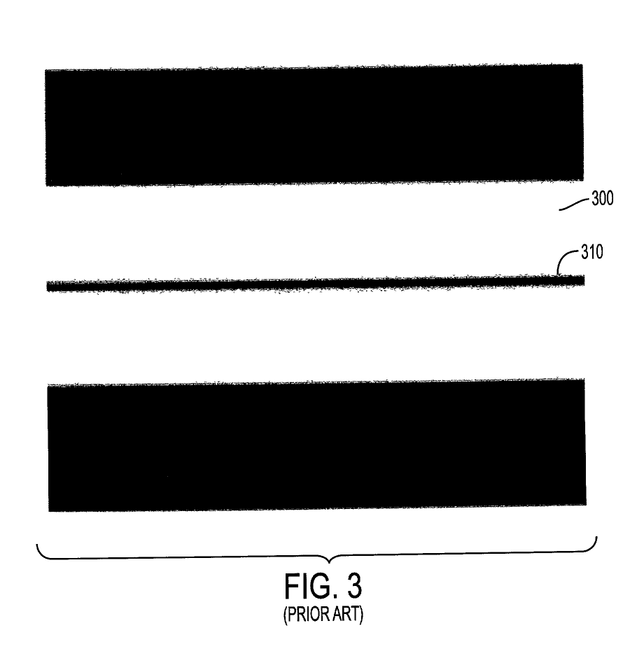

FIG. 4 shows an example of an image of an optical fiber having an off-center core obtained by a prior art system.

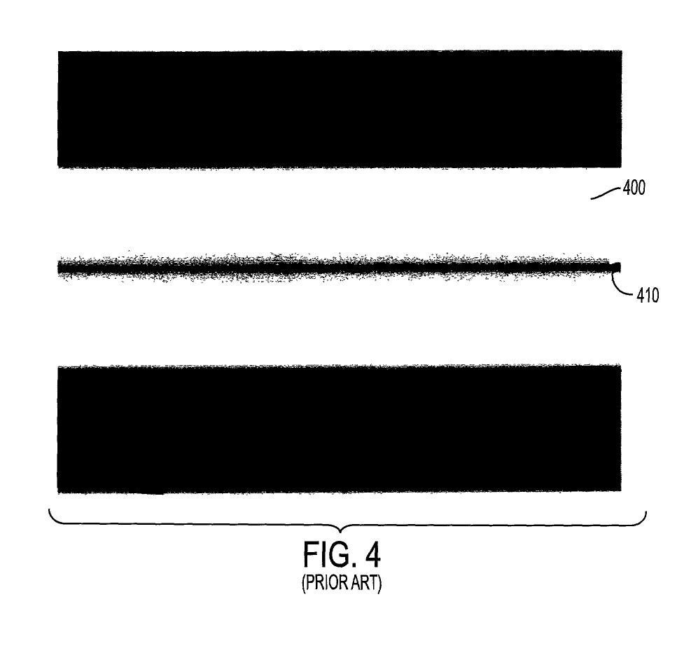

FIG. 5 shows the optical fiber image of FIG. 3, obtained by a prior art system, at an increased magnification.

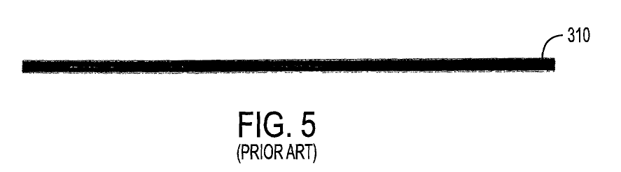

FIG. 6 shows the optical fiber image of FIG. 4, obtained by a prior art system, at an increased magnification.

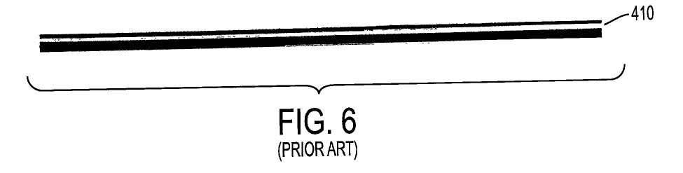

FIG. 7 shows an optical fiber image having a substantially precise alignment that results from processing according to an example of the present invention.

FIG. 8 shows an optical fiber image having a misaligned core that results from processing according to an example of the present invention.

FIG. 9 shows the optical fiber image of FIG. 7 at an increased magnification.

FIG. 10 shows the optical fiber image of FIG. 8 at an increased magnification.

### DETAILED DESCRIPTION OF PREFERRED EMBODIMENTS

Before beginning a detailed description of the invention, it should be noted that, when appropriate, like reference numerals and characters may be used to designate identical, corresponding or similar components in differing figure drawings. Further, in the detailed description to follow, example embodiments and values may be given, although the present invention is not limited thereto.

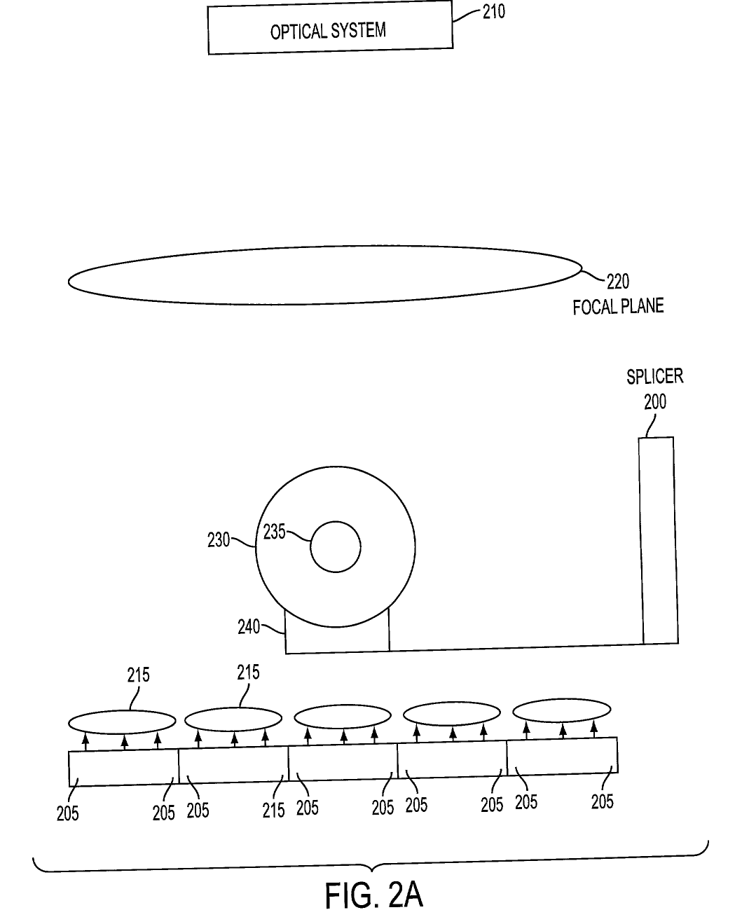

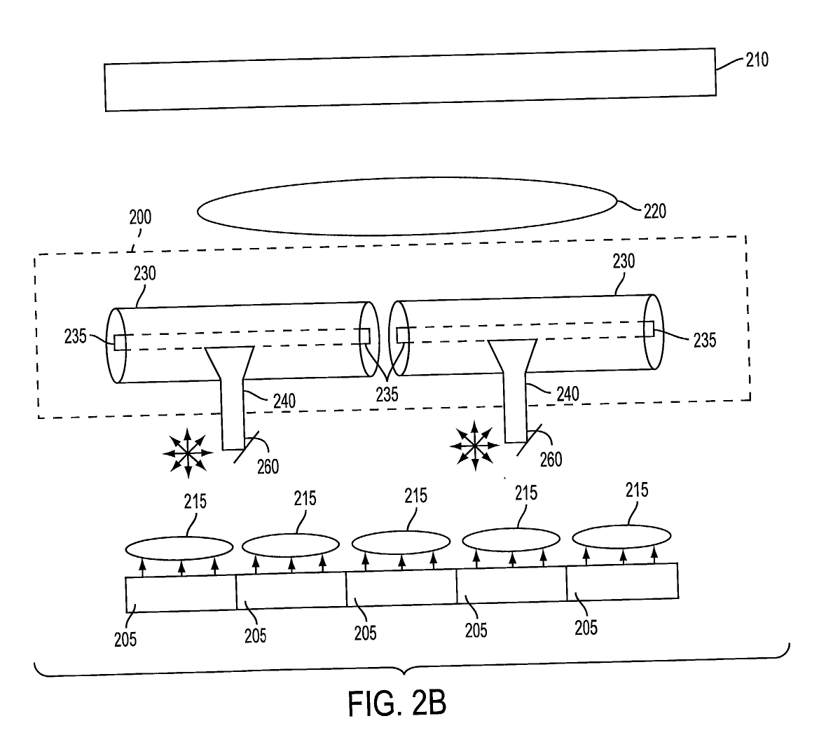

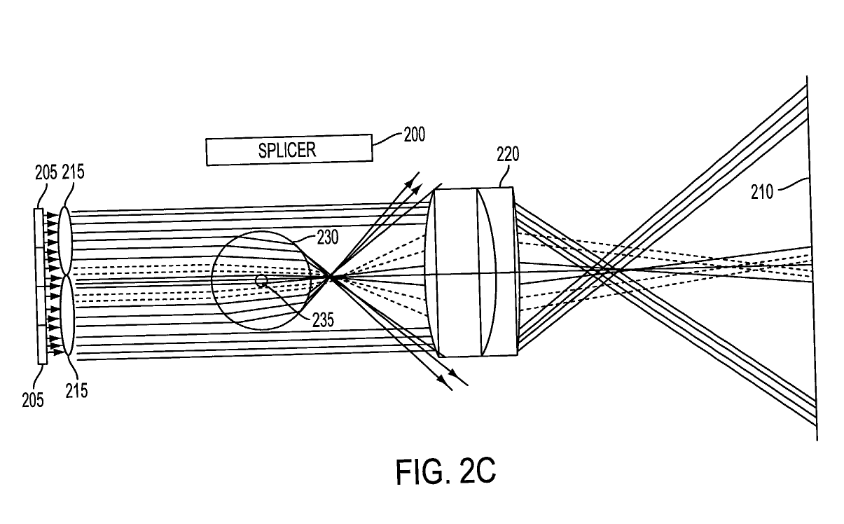

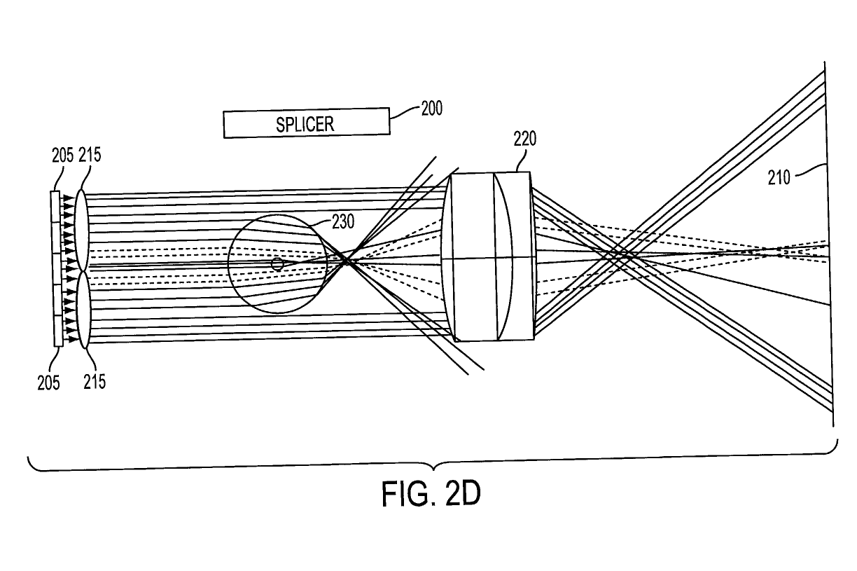

According to an example embodiment of the present invention shown in FIGS. 2A and 2B, optical fiber splicer 200 is provided to splice together an end portion of two optical fibers 230 at splice point 250. The optical fiber splicer 200 may include a clamp 240 that is disposed on a base of the splicer 200. The clamp 240 may be utilized to hold the optical fibers 230 in place and is preferably adjustable for precise placement of the respective optical fibers 230. That is, the clamp 240 is rotatable upon axis 260, which is attached to a base of the splicer 200, and is therefore fully rotatable in the (x, y, z) directions so that the clamps 240 may be adjusted as necessary to provide substantially precise alignment of the cores 235 of the optical fibers 230 upon implementation of the present invention. The adjustment of the clamp 240 includes being moved in the axial direction of either of the optical fibers 230.

Further, the optical fiber splicer 200 may include light emitting diodes (LEDs) 205 that emit light onto the optical fibers 230. The light emitted onto the optical fibers 230 may be collimated by lenses 215, or “light pipes”, that may be disposed adjacent to the LEDs 205, to thereby simulate a point source at infinity and located behind a 3 mm aperture. Thus, divergent rays may be eliminated and the rays may enter the optical fibers 230 in parallel. FIGS. 2A and 2B merely show the direction of light emitted from LEDs 205, whereby FIGS. 2C and 2D show more complete light paths of the light emitted from LEDs 205 that would be produced by the examples of FIGS. 2A and 2B.

Focal plane 220 may be disposed orthogonally to the axial direction of the splice point 250 between the two optical fibers 230, and an optical system 210, which may be utilized to facilitate visual alignment of the optical fibers 230 that are to be fused together, may also be disposed orthogonally to the axial direction of the splice point 250, beyond the focal plane 220. The optical system 210 may include, for example, a digital image camera or a digital video camera. Thus, light rays from the LEDs 205 may follow a path through the lenses 215, then be subjected to refraction and vignetting by the core 235 and cladding of the optical fibers 230, and then defocused by focal plane 220 onto the optical system 210.

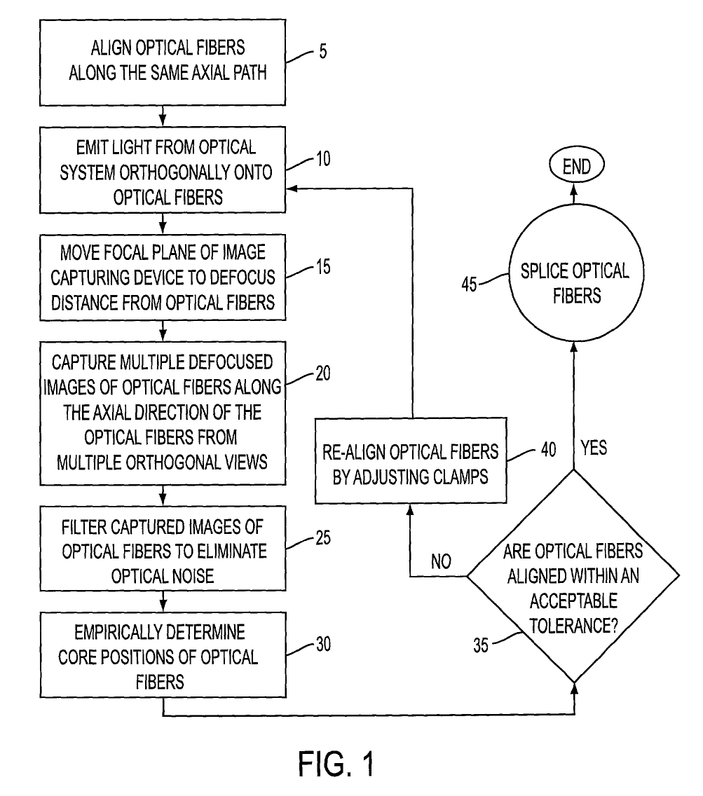

An example embodiment of the method according to the present invention, which may include computer-implemented instructions, or a program, in conjunction with splicer 200, is shown in FIG. 1, with reference to the system of FIGS. 2A through 2D. FIG. 2A is a schematic block diagram of an example of the present invention, and FIG. 2B is a profile of the same schematic block diagram. FIGS. 2C and 2D show the light paths according to the example of FIGS. 2A and 2B for, respectively, perfectly aligned cores 230 at the splice point 250 and mis-aligned cores 230 at the splice point 250, whereby the core offset is an exemplary value of 0.1 μm.

A first step 5 includes holding in place the optical fibers 230 using optical fiber clamps 240 so that the end portions of the two optical fibers 230 to be spliced together at splice point 250 are aligned along the same axial path. Light may then be emitted from the optical system 210, as described above, in step 10. The focal plane 220, which is orthogonal to the axial direction of the splice point 250 between the two optical fibers 230, may then moved to a certain defocus distance away from the optical fibers and towards the optical system to defocus the image of the fibers.

For a splicer having the specifications described above, the desirable defocus distance may be 300-350 μm away from the cladding of the optical fibers at the splice point, although the present invention is not so limited. The defocus distance is the distance at which the lens effect line may appear to a viewer in the form of three parallel lines, encompassing approximately, for example, 40% of the width of an optical fiber. Further, the defocus distance may shift, and therefore may be determined either empirically or by optical modeling for different splicer optical system designs. As the image of the splice point of the optical fibers 230 is defocused by orthogonally moving the objective plane 220 of the optical system away from the axial direction of the optical fibers 230 to the predetermined defocusing distance, in the exemplary range of 300 to 350 μm, the light reflecting from the inside portion of the cladding behind the core of the optical fibers 230 may produce multiple parallel line images corresponding to the optical fiber core 235 that are projected by the objective plane 220 onto a charge coupled device (CCD) 210.

The optical system 210, which may include , a digital image camera or a digital video camera as described above, may then proceed to capture multiple images along the axial path of the optical fibers 230 at intervals of, for example, 5 μm from more than one orthogonal view, as in step 20. As an example, over forty (40) images of the optical fibers 230 may be taken, from both of two orthogonal perspectives. That is, multiples image samples may be taken along the axial path of the optical fibers 230 from different orthogonal vantage points, and image samples that differ excessively from the average may be discarded, and the remaining samples may be summed up.

A fast Fourier transform (FFT) “brick wall” filter with a passband of 0.04-0.08 Hz (based on 1.5 μm/pixel) may then be used, in step 25, to remove the effects of optical imperfections from the gathered images of the optical fibers 230 and their cores 235. Such optical imperfections may include electronic noise on the CCD, debris on the optical fibers, etc. The filtering is also implemented to isolate the data pertaining to the cores 235 of the optical fibers 230, at the splice position 250. In the alternative, the filtering may be accomplished using Gaussian filtering or other methods to determine spatial frequency components that correlate well with the position of the cores of the optical fibers 230. If it is desirable to locate local maxima and minima of the data, a cubic spline method, for example, may be used. The multiple images are captured from multiple orthogonal perspectives along the axial path of the optical fibers to take into account core displacements that are parallel to the line of sight thereof. Lastly, the positions of the cores 235 of the optical fibers 230, specifically the cores 235 at the splice position, are empirically determined from the filtered data.

As a result, using the methodology described above, FIGS. 2C and 2D, respectively show how, for a perfectly centered core and an off-centered core (with an exemplary off-set of 0.1 μm), an image of the splice point of the optical fibers, defocused by orthogonally moving the objective plane of the optical system away from the axial direction of the optical fibers to a predetermined defocusing distance in the exemplary range of 300 to 350 μm, results in the light reflecting from the inside portion of the cladding behind the core 235 of the optical fibers 230 producing multiple parallel line images corresponding to the optical fiber core that are projected by the objective plane 220 onto a charge coupled device (CCD) 210.

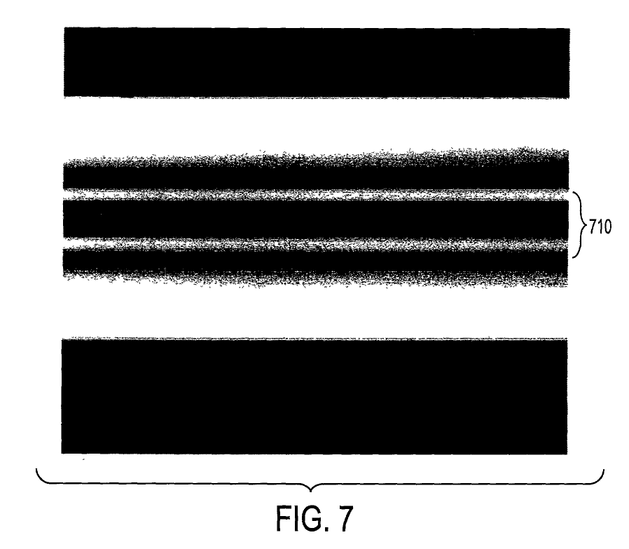

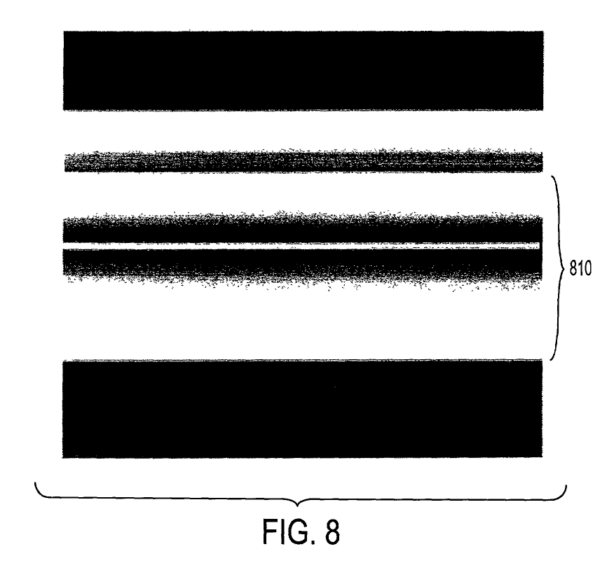

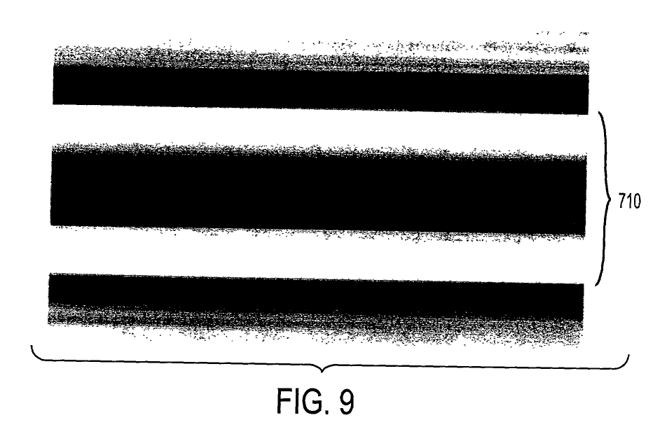

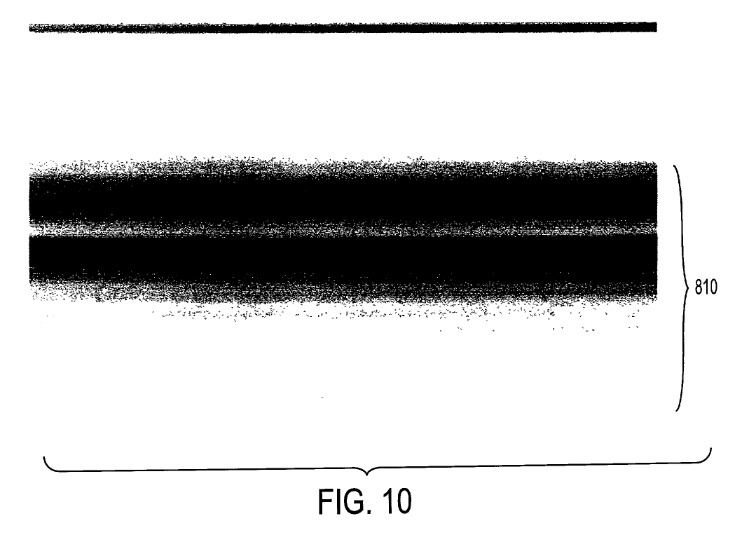

Using a CAD-produced negative image to more clearly show the intended characteristics, FIG. 7 shows a defocused image of an optical fiber having a perfectly centered core, which can be seen by the shiftless lens effect line 710, and FIG. 8 shows a defocused image of an optical fiber having the lens effect line 810 having a minute shift corresponding to the 1 μm eccentric core. FIGS. 7 and 8 are magnified images of the optical fibers on the order of 400×. In FIG. 8, the misalignment of the optical fiber cores is magnified many times greater than 1 μm, thus removing any limitations that may be imposed by a 1.5 μm/pixel CCD resolution. FIGS. 9 and 10, which are also CAD-produced negative images, show the images of FIGS. 7 and 8 at a magnification of 800×.

However, if after the positions of the cores 235 of the optical fibers 230 are determined in step 30 to still be mis-aligned in decision 35, the axes 260 are adjusted so that the clamps 240 re-align the optical fibers 230 as necessary, as in step 40. Then, the methodology resumes at step 10 as described above, and the iterations of the method beginning at step 10 are repeated until the cores 235 of the optical fibers 230 are aligned within an acceptable tolerance for splicing thereof.

This concludes the description of the example embodiments. Although the present invention has been described with reference to illustrative embodiments thereof, it should be understood that numerous other modifications and embodiments can be devised by those skilled in the art that will fall within the scope and spirit of the principles of the invention. More particularly, reasonable variations and modifications are possible in the component parts and/or arrangements of the subject combination arrangement within the scope of the foregoing disclosure, the drawings and the appended claims without department from the spirit of the invention. In addition to variations and modifications in the component parts and/or arrangements, alternative uses will also be apparent to those skilled in the art.

I claim:

1. In an optical fiber splicer having an imaging device, a method implemented by the imaging device for aligning axial cores of optical fibers, said method comprising the steps of:
(a) aligning the optical fibers along a same axial path;
(b) emitting light from the imaging device onto the optical fibers orthogonally to the axial path of the optical fibers;
(c) defocusing an image of the optical fibers;
(d) capturing the image of the optical fibers; and
(e) empirically determining a core position of the optical fibers.

2. A method according to claim 1, further comprising the steps of:
(f) re-aligning the optical fibers; and
(g) repeating said steps (b) through (e) until the empirically determined core position of the optical fibers is within an acceptable tolerance.

3. A method according to claim 1, wherein after said step (d) and before said step (e), the method further includes the steps of:
(d1) performing a predetermined number of iterations of said steps (a) through (d) along an axial direction of the optical fibers; and
(d2) filtering each result of said step (d1).

4. A method according to claim 3, further comprising the steps of:
(f) re-aligning the optical fibers; and
(g) repeating said steps (b) through (e) until the empirically determined core position of the optical fibers is within an acceptable tolerance.

5. A method according to claim 4, wherein the imaging device performs said step of emitting light onto the optical fibers orthogonal by emitting light from a light emitting diode (LED) and a series of lenses adjacent thereto.

6. A method according to claim 4, wherein the imaging device performs said step of defocusing an image of the optical fibers by orthogonally moving a focal plane of the imaging device away from the axial direction of the optical fibers to a defocus distance.

7. A method according to claim 6, wherein the defocus distance is 300-350 μm.

8. A method according to claim 6, wherein an image of the optical fibers at the defocus distance includes three parallel lines, encompassing substantially 40% of a width of the optical fibers.

9. A method according to claim 4, wherein the imaging device performs the predetermined number of iterations of said steps (a) through (d) along an axial direction of the optical fibers from multiple orthogonal views.

10. A method according to claim 9, wherein the imaging device performs 40 iterations of said steps (a) through (d) along the axial direction of said optical fibers from two orthogonal views.

11. A method according to claim 4, wherein said step of filtering is performed by a fast-Fourier transform band-pass filter to remove optical noise from the images of said optical fibers.

12. A method according to claim 11, wherein said fast-Fourier transform band-pass filter has a passband of 0.04 to 0.08 Hz.

13. A computer-readable medium in an imaging device of an optical fiber splicer for aligning axial cores of optical fibers, said computer-readable medium having computer-executable instructions for performing steps comprising:
(a) aligning the optical fibers along a same axial path;
(b) emitting light from the imaging device onto the optical fibers orthogonally to the axial path of the optical fibers;
(c) defocusing an image of the optical fibers;
(d) capturing the image of the optical fibers; and
(e) empirically determining a core position of the optical fibers.

14. A computer-readable medium according to claim 13, comprising further computer-executable instructions for performing the steps of:
(f) re-aligning the optical fibers; and
(g) repeating said steps (b) through (e) until the empirically determined core position of the optical fibers is within an acceptable tolerance.

15. A computer-readable medium according to claim 13, wherein after said step (d) and before said step (e), the computer-executable instructions include the steps of:
(d1) performing a predetermined number of iterations of said steps (a) through (d) along an axial direction of the optical fibers; and
(d2) filtering each result of said step (d1).

16. A computer-readable medium according to claim 13, comprising further computer-executable instructions for performing the steps of:
(f) re-aligning the optical fibers; and
(g) repeating said steps (b) through (e) until the empirically determined core position of the optical fibers is within an acceptable tolerance.

17. A computer-readable medium according to claim 16, wherein said computer-executable instruction for emitting light onto the optical fibers orthogonal is performed by emitting light from a light emitting diode (LED) and a series of lenses adjacent thereto.

18. A computer-readable medium according to claim 16, wherein said computer-executable instruction for defocusing an image of the optical fibers is performed by orthogonally moving a focal plane of the imaging device away from the axial direction of the optical fibers to a defocus distance.

19. A computer-readable medium according to claim 18, wherein the defocus distance is 300-350 μm.

20. A computer-readable medium according to claim 18, wherein an image of the optical fibers at the defocus distance includes three parallel lines, encompassing substantially 40% of a width of the optical fibers.

21. A computer-readable medium according to claim 16, wherein a predetermined number of iterations of said steps (a) through (d) is performed along an axial direction of the optical fibers from multiple orthogonal views.

22. A computer-readable medium according to claim 21, wherein 40 iterations of said steps (a) through (d) are performed along the axial direction of said optical fibers from two orthogonal views.

23. A computer-readable medium according to claim 16, wherein said step of filtering is performed by a fast-Fourier transform band-pass filter to remove optical noise from the images of said optical fibers.

24. A computer-readable medium according to claim 23, wherein said fast-Fourier transform band-pass filter has a passband of 0.04 to 0.08 Hz.

25. An optical fiber splicer, comprising:
alignment clamps that hold optical fibers along a same axial path;
an optical system that captures images of the optical fibers;
a light emitting source, disposed adjacent to said optical system and including a light emitting diode and plural lenses, that emits light onto said optical fibers orthogonal to an axial direction of said optical fibers;
said optical system including a focal plane that adjustably moves in a direction orthogonal to the axial direction of said optical fibers;
a filter that removes optical noise from plural images of said optical fibers; and
a processor that empirically determines a core position of said optical fibers.

26. An optical splicer according to claim 25, wherein said optical system captures the plural images of said optical fibers after said focal plane has been moved away from the axial direction of said optical fibers to a defocus distance.

27. An optical splicer according to claim 26, wherein said defocus distance is 300-350 μm.

28. An optical splicer according to claim 26, wherein an image of said optical fibers at said defocus distance includes three parallel lines, encompassing substantially 40% of a width of said optical fibers.

29. An optical splicer according to claim 26, wherein said optical system takes a predetermined number of defocused images of said optical fibers along the axial direction of said optical fibers from multiple orthogonal views.

30. An optical splicer according to claim 29, wherein said optical system takes 40 defocused images of said optical fibers along the axial direction of said optical fibers from two orthogonal views.

31. An optical splicer according to claim 25, wherein said filter is a fast-Fourier transform band-pass filter.

32. An optical splicer according to claim 3 1, wherein said fast-Fourier transform band-pass filter has a passband of 0.04 to 0.08 Hz.
